(19) United States
(12) Patent Application Publication
(10) Pub. No.: US 2014/0143349 A1
(43) Pub. Date: May 22, 2014

(54) Distributed Architecture Data Transfer System

(71) Applicant: Jason E. Feser, San Antonio, TX (US)

(72) Inventor: Jason E. Feser, San Antonio, TX (US)

(21) Appl. No.: 13/680,628

(22) Filed: Nov. 19, 2012

(51) Int. Cl. H04L 12/58

(52) U.S. Cl. CPC H04L 51/08
USPC 709/206

(57) ABSTRACT

Systems, methods and computer program products for facilitating data transfer and synchronization between computing devices are disclosed. In an aspect, an enterprise editing platform allows a plurality of contributors to access and alter the same data layer without the use of proprietary server architectures. Data layers are edited by users on local devices and synced remotely by the enterprise editing platform. The data layer is updated via changes sent via ports, protocols, and services associated with electronic mail. In as aspect, updates to the data layer are sent and received via email attachments. Users may initiate sending and retrieving updates to the data layer. In another aspect, a module of the enterprise editing platform sends data layer updates to email addresses associated with each contributor.

### FIELD OF THE DISCLOSURE

The present disclosure generally relates to data management and more particularly to systems, methods, and computer program products for facilitating data transfer and synchronization across multiple computing devices.

### BACKGROUND

It may be advantageous to share data throughout a group of individuals, companies and other entities. Often, information is collected by, for example, an individual within the group who, in turn, wishes to securely share their information with the rest of the group. Information shared may include, but is not limited to, text, audio, images, video, contact information and various other databases or data stores.

Storing, sharing, manipulating, and syncing information (“enterprise editing”) collected by individuals is especially important for geospatial information systems (GIS). GIS are designed to receive geographical data from a variety of sources and provide a platform for analysis and usage of such data. In some situations, geographic data is input into an Internet-hosted digital spreadsheet which is accessible and editable by multiple individuals. These individuals may be assigned physical areas where they are to collect data of interest and upload the data to the Internet-hosted digital spreadsheet via an Internet-enabled mobile computing device.

In addition to GIS solutions, various other platforms enable the storing, sharing, manipulating, and syncing of information between computing devices associated with members of the group. Such sharing platforms are commonly referred to as “cloud storage solutions”, “content management systems”, “enterprise editors”, and the like. Current platforms utilize ports, protocols, and services specifically designed to enable data to be securely stored, shared, and synced between multiple computing devices. Such platforms may enable enterprise editing across a single network domain or across multiple network domains. Such platforms, however, require significant investment in hardware and proprietary (and sometimes faulty) database management software. Additionally, one or more administrators are necessary to monitor and maintain the integrity of the platform and its associated servers, driving up the cost of platform operation.

Networks in different geographic areas may have different capabilities. For example, the telecommunications network capabilities of third-world countries or lesser-developed regions may not comprise or support the ports, protocols and services necessary to enable secure enterprise editing with individuals within such geographic areas. In order to facilitate enterprise editing in such environments, two approaches have been taken.

The first approach is to build the necessary infrastructure in the geographic area of interest. This approach is costly and time consuming. It may also be dangerous if the geographic area of interest is a war zone or natural disaster area.

The second approach attempts to provide a multiple-domain solution. Such approaches typically involve some, but not all, of the stake holders entreating information technology managers to relax security protocols such that enterprise editing may be carried out with parties in areas with poor telecommunications network capabilities. This approach yields a minimum solution which is useful to only a minority of stake holders and compromises security.

Given the foregoing, systems, methods, and computer program products are needed for facilitating data transfer and synchronization across multiple computing devices. Facilitation of enterprise editing across multiple domains without compromising functionality or security is needed. Rapid deployment of such systems, methods, and computer program products is also needed.

Additionally, systems, methods, and computer program products are needed that facilitate a data transfer platform without requiring the development, installation, or management of proprietary server architectures.

### SUMMARY

This Summary is provided to introduce a selection of concepts. These concepts are further described below in the Detailed Description. This Summary is not intended to identify key features or essential features of the disclosures subject matter, nor is this Summary intended as an aid in determining the scope of the disclosed subject matter.

Aspects of the present disclosure meet the above-identified needs by providing systems, methods, and computer program products for facilitating data transfer and synchronization across multiple computing devices. In some aspects, at least one computing device is connected to a telecommunications network of limited capability.

In an aspect, data transfer and synchronization across multiple computing devices is facilitated by an enterprise editing platform configured to utilize a network resource common across all network domains, namely, electronic mail (“email”). Email communication has been deliberately engineered to provide uniform functionality across network domains. That is, email is a cross-domain solution, suitable to underpin a cross-domain enterprise editing platform.

Utilizing email messaging to facilitate data transfer and synchronization allows an enterprise editing platform to be created between multiple network domains in the time it takes to install the requisite software on individual computing devices rather than the more lengthy process of creating traditional infrastructure, such as installing hardware and developing proprietary (and sometimes faulty) database management software.

Additionally, unlike previous enterprise editing systems, the present disclosure avoids the use of specific ports and specialized protocols to enable enterprise editing. The information assurance and information security practice of legacy systems are typically designed to “lock down” databases of information to prevent corruption, intrusion, and preserve database taxonomy.

Contributors to enterprise editing platforms typically want greater access to the information contained therein, placing them at odds with information assurance and information security personnel. Aspects of the present disclosure allow for a single data manager to access a central, information database and monitor the community of contributors, accepting, rejecting, or modifying contributor-supplied data. Contributors send data and receive updates via email and never directly edit or access the information database, thus providing contributors with access while preserving the security and integrity of the information database.

In an aspect of the present disclosure, an index file is created comprising a plurality of object identifiers. At least one object identifier is associated with a portion of a data layer. The data layer comprises at least one file to be shared over a platform according to the present disclosure. At least one object identifier is also reserved for later association with changes made to the data layer by a contributor.

The data layer and index file are stored on an information database and the data layer is emailed to at least one contributor. Contributors make changes to the data layer they received and return data bundles via email. A data bundle comprises at least one contributor change to the data layer. This contributor change is imported, assigned a reserved object identifier, and integrated with the stored data layer. Thus, an updated data layer is created. The updated data layer is then sent to the contributor community via email.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is a block diagram of an exemplary system for facilitating data transfer and synchronization across multiple computing devices, according to an aspect of the present disclosure.

FIG. 2 is a block diagram of an exemplary system for facilitating the uploading of contributor changes and monitoring data layers in a data transfer and synchronization platform, according to an aspect of the present disclosure.

FIG. 3 is a flowchart of a process for facilitating the creation and management of a data layer, according to an aspect of the present disclosure.

FIG. 4 is a flowchart of a process for facilitating the creation, alteration, and management of a data layer wherein a contributor responds to a data manager's corrections, according to an aspect of the present disclosure.

FIG. 5 is a flowchart of a process for facilitating the creation of a data transfer and synchronization platform, according to an aspect of the present disclosure.

FIG. 6 is a flowchart of a process for generating and sending contributor changes, according to an aspect of the present disclosure.

FIG. 7 is a flowchart of a process for generating and sending contributor changes, wherein the contributor responds to a data manager's corrections, according to an aspect of the present disclosure.

FIG. 8 is a screenshot of a portion data manager tool displayed within a GUI, according to an aspect of the present disclosure.

FIG. 9 is a screenshot of a portion data manager tool displayed within a GUI, according to an aspect of the present disclosure.

FIG. 10 is a block diagram of an example computing system useful for implementing the present disclosure.

### DETAILED DESCRIPTION

The present disclosure is directed to systems, methods, and computer program products for facilitating data transfer and synchronization across multiple computing devices.

Aspects of the present disclosure may be utilized to create, maintain, alter, and otherwise provide enterprise editing of files and other forms of data wherein contributor changes are sent and received via email messages.

The terms electronic mail, email, and email attachment may collectively refer to an email message. The email message may further comprise an attached file containing data.

Aspects of the present disclosure may facilitate enterprise editing of a data layer as well as the receiving and distribution of geospatial data from multiple contributors.

A data layer comprises at least one file or other data to be transferred and synchronized in accordance with the present disclosure. Changes to a data layer stored on an information database may be submitted by one or more contributors. A contributor imports a copy of the data layer onto a contributor computing device, where the contributor updates the data layer stored therein by deleting data, changing data, and/or inputting additional data (e.g., geospatial information, text, images, and the like). Such updates are contributor changes. A data bundle comprising one or more contributor changes is generated and sent via email message. The email containing the data bundle is received by a data manager or a software module. The contributor change is imported onto a computing device and assigned an object identifier. Thereafter, the contributor change is integrated into the data layer contained in the information database, generating an updated data layer. The updated data layer is then sent to one or more contributors via an email message.

In another aspect, only the portions necessary to synchronize data layers stored on contributor computing devices with the updated data layer are sent to one or more contributors.

In an aspect, the data layer may comprise a master index file (.MIF file) and master topology file (.MTF file). The .MIF file comprises one or more files comprising assigned and reserved object identifiers. The .MIF may further comprise one or more record files of the assignment of object identifiers to contributor changes. The .MTF file comprises one or more files comprising at least one file or other data to be transferred and synchronized. In an aspect, such files comprise one or more features and associated records.

In an aspect, a data layer is a plurality of files. Where the data layer is associated with transfer and synchronization of geospatial data, the data layer may comprise a shapefile.

The shapefile is a collection of files that contain geospatial information for a chosen area. The shapefile is, itself, a plurality of files. The shapefile may comprise shape.shp, shape.shx, shape.dbf, and shape.prj. *.shp files may contain the geometry of the features in the data layer, such as lines points, or polygons. *.dbf files may contain attributes that describe one or more features contained in a *.shp file. *.shx files may contain a spatial index of all the features. Thus, *.shx files enable features to be quickly located within a GUI presented to a user. *.prj files describe the map projection and datum that each feature is measured against.

By way of example, where a data layer comprises a shapefile describing a road, the shapefile comprises roads.shp, roads.dbf, roads.shx, and roads.prj. Roads.shp details poly lines describing such roads. Roads.dbf comprises attributes that describe the characteristics of each road. Roads.shx comprises information detailing where one road is with respect to another road. Roads.prj comprises information detailing where the coordinates contained in the data layer are with respect to a reference point (e.g., the surface of the earth, a latitude and longitude, and the like).

In an aspect, portions of *.shp, *.shx, and *.dbf files are associated with an object identifier.

In an aspect, one or more files comprising the data layer and contributor changes, such as shapefiles, are written to an .XML or JSON file. Such files may be stored in a NoSQL database architecture. Contributor changes may be contained within .XML or JSON files. In an aspect, a JSON files comprises a contributor change made by a particular contributor. The JSON file is received and assigned an object identifier which was previously reserved for that contributor.

In another aspect, the data layer is a NoSQL database and the data layer comprises geospatial data. Each contributor change may be a file, such as an .XML or JSON file. Each file comprises the object identifier information, geometry, attributes, and projection associated with the contributor change. The data layer further comprises an index file comprising a record of assigned and reserved object identifiers. Such an aspect enables the index file to represent a complete, usable record of what information is contained in the data layer, reducing risk of corruption of the stored data due to editing by multiple individuals.

Alternative file names may be used and the shapefile may further comprise additional files. Additional files may be necessary where additional information (e.g., the location of items of interest, locations of previous ambushes, average number of people present at dawn in a location, and the like) is collected, transferred, and synchronized.

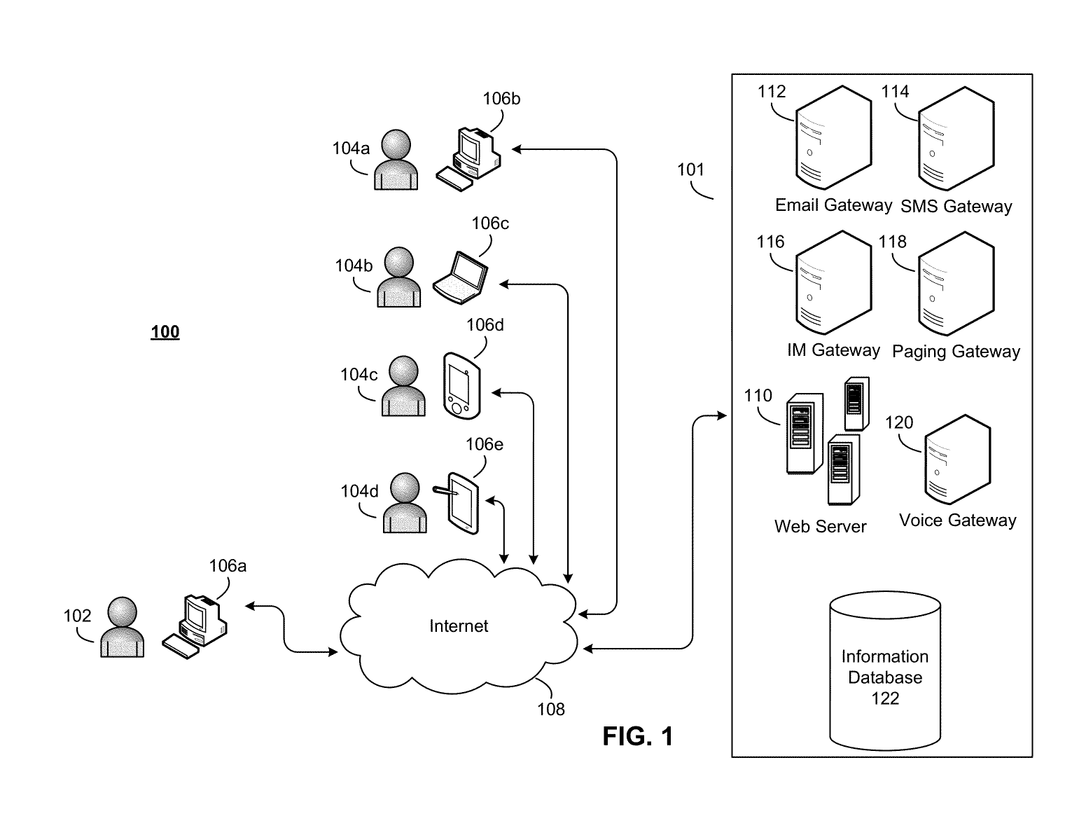

Referring now to FIG. 1, a block diagram of an exemplary system 100 for facilitating data transfer and synchronization across multiple computing devices, according to an aspect of the present disclosure, is shown.

Cloud-based, Internet-enabled device communication system 100 includes one or more data managers 102 and one or more contributors 104 (shown as contributors 104a-d in FIG. 1) accessing—via a computing device 106 (shown as computing devices 106a-e in FIG. 1) and a network 108, such as the global, public Internet—an application service provider's cloud-based, Internet-enabled infrastructure 101. In various aspects, computing device 106 may be configured as: a desktop computer 106a,b; a laptop computer 106c; a Personal Digital Assistant (PDA) or mobile telephone 106d; a tablet or mobile computer 106e; any commercially-available intelligent communications device; or the like.

As shown in FIG. 1, in an aspect of the present disclosure, an application service provider's cloud-based, communications infrastructure 101 may include one or more web servers 110, an email gateway 112, an SMS gateway 114, an Instant Message (IM) gateway 116, a paging gateway 118, a voice gateway 120, and an information database 122. Information database 122 may be configured to store one or more data layers and index files. In alternate aspects, information database 122 may comprise one or more data stores within (or remotely located from) infrastructure 101 or be a memory included in (or coupled to) web server 110.

In an aspect of the present disclosure, information database 122 stores one or more data layers and one or more index files corresponding to the data layers. An index file is a digital record comprising a plurality of object identifiers. At least one object identifier is associated with a portion of a data layer. The data layer comprises at least one file to be shared over a multiple devices 106 according to the present disclosure. At least one object identifier is also reserved for later association with changes made to the data layer by a contributor.

Reserved object identifiers in sequence (e.g., object identifiers nos. 51-100) may be saved for use by a specific contributor. This reduces or eliminates the necessity of reassigning object identifiers to previously identified portions of the data layer as contributors make changes to the data layer. In another aspect, sequential reserved object identifiers may be saved for assignment to changes made or received during a specific time window. As will be appreciated to those skilled in the art after reading the description herein, object identifiers may be assigned and reserved via other means.

Where a NoSQL database is used to implement aspects of the present disclosure, reserved object identifiers may be described as “null reserved” until the reserved object identifier is assigned to a contributor change.

An application service provider—an individual person, business, or other entity—may allow access, on a free registration, paid subscriber and/or pay-per-use basis, to infrastructure 101 via one or more World-Wide Web (WWW) sites on the Internet 108. Thus, system 100 is scalable such that multiple data managers 102 and contributors 104 may utilize it to facilitate data transfer and synchronization from information database 122 to computing devices 106.

As will also be appreciated by those skilled in the relevant art(s), in an aspect, various screens (e.g., login, admin, account, information, resource, logout, communications, and the like) would be generated by server 110 in response to input from data managers 102 and contributors 104 over Internet 108. That is, in such an aspect, server 110 is a typical web server running a server application at a website which sends out webpages in response to Hypertext Transfer Protocol (HTTP) or Hypertext Transfer Protocol Secured (HTTPS) requests from remote browsers on various computing devices 106 being used by various data managers 102 and contributors 104. Thus, server 110 is able to provide a graphical user interface (GUI) to data managers 102 and contributors 104 of system 100 in the form of webpages. These webpages are sent to the creator's and contributor's PC, laptop, mobile device, PDA or the like device 106, and would result in the GUI being displayed.

As will be appreciated by those skilled in the relevant art(s) after reading the description herein, alternate aspects of the present disclosure may include providing one or more tools for facilitating the transfer and synchronization of data between information database 122 and computing devices 106 as a stand-alone system (e.g., installed on one server) or as an enterprise system wherein all the components of infrastructure 100 are connected and communicate via an inter-corporate Wide Area Network (WAN) or Local Area Network (LAN). For example, in an aspect where contributors 104 are all personnel/employees of the same company, the present disclosure may be implemented as a stand-alone system, rather than as a web service (i.e., Application Service Provider (ASP) model utilized by various users from different entities/organizations/companies) as shown in FIG. 1.

As will also be appreciated by those skilled in the relevant art(s) after reading the description herein, alternate aspects of the present disclosure may include providing the tools for facilitating data transfer and synchronization between information database 122 and computing devices 106 via a browser pre-installed with an applet or a browser with a separately-downloaded applet on such devices 106. That is, as will also be apparent to one skilled in the relevant art(s) after reading the description herein, the applet that facilitates the enterprise editing platform disclosed herein and, in particular, may be part of the “standard” browser that ships with computing device 106 or may be later added to an existing browser as part of an “add-on” or “plug-in.”

In another aspect of the present disclosure, tools are provided for facilitating data transfer and synchronization between a plurality of computing devices 106, in lieu of an information database 122 existing in a distinct infrastructure 101. In such an aspect, one or more computing devices 106 comprise an information database 122, which is configured for access by other computing devices 106. In an alternate aspect, infrastructure 101 is computing device 106 utilized by contributor 104 to access the data layer and transfer and synchronize data with other contributors 106. In yet another aspect, infrastructure is computing device 106 utilized by data manager 102 to access the data layer and monitor, approve, modify, reject, verify, or otherwise manipulate contributor changes received via email message.

In another aspect of the present disclosure, a data manager tool is provided. The data manager tool is configured to allow one or more data managers 102 to monitor, approve, modify, reject, verify, or otherwise manipulate contributor changes received via email message before the contributor change is integrated into the data layer.

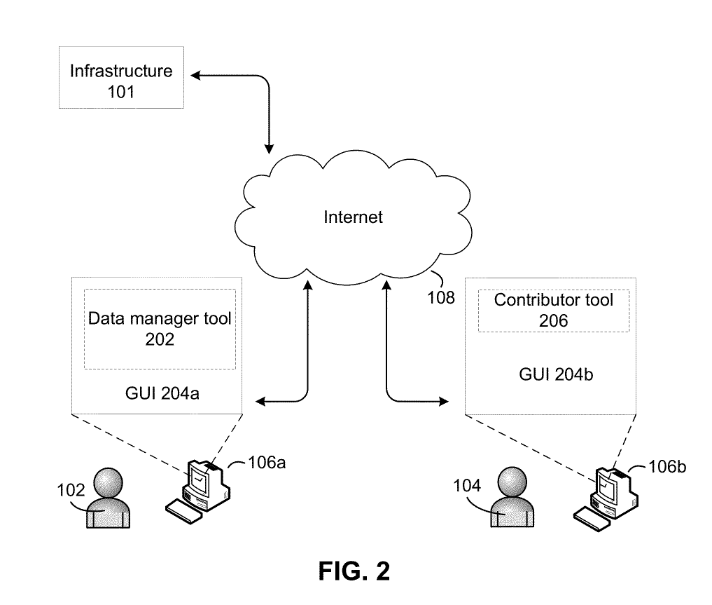

Referring now to FIG. 2, a block diagram of an exemplary system for facilitating the uploading of contributor changes and monitoring data layers in a data transfer and synchronization platform, according to an aspect of the present disclosure, is shown.

Contributors 104 and data managers 102 may send and receive data from information database 122 contained within infrastructure 101 via computing devices 106 (shown as computing devices 106a-b in FIG. 2) permanently or temporarily connected to Internet 108. Contributors 104 may send and receive data from information database 122 by sending email messages via Internet 108 to specified email addresses (e.g., contributions@domain.com). Data layers, updated data layers, and portions of an updated data layer may be sent from information database 122 to contributors 104 via email message. Such email messages may be sent to email addresses unique to individual contributors 104 (e.g., contributor.1@domain.com, contributor.2@domain.com, etc.). In an alternative aspect, such email messages are sent to an email address accessible by a plurality of contributors 104 (e.g., updates@domain.com). In another aspect, such email messages are sent to one or more email addresses which are accessed by software modules. The software modules in turn update data layers stored on a contributor's computing devices 106, without direct command from the contributor 104.

Contributors 104 may access and update one or more data layers via a contributor tool 206 presented to contributor 104 via a GUI 204 (shown as GUI 204a-b in FIG. 2). GUI 204 may be presented to contributor 104 via computing device 106b (shown as computing device 106a-b in FIG. 2). Contributor tool 206 may be one or more software modules configured to facilitate access and editing of a data layer stored on a contributor computing device 106. Contributor tool 206 may be configured to save changes contributor 104 makes to a data layer and prompt contributor 104 to send an email message containing such data layer changes upon completion of a data layer editing session. Contributor tool 206 may also prompt such sending at regular intervals, whenever contributor tool 206 detects a change to the data layer stored on computing device 106b, or according to one or more criteria as will be apparent to those skilled in the relevant art(s) after reading the description herein.

In an alternate embodiment, contributor tool 206 does not directly enable contributor 104 to access or edit files. Rather, the data layer comprises one or more files accessible via the file system of computing device 106b. Contributor 104 accesses such files via the file system of computing device 106b and utilizes editing programs (e.g., a word processor) to view and modify such files. Contributor tool 206 is configured to monitor one or more files or folders which comprise a portion of the data layer and generate a data bundle comprising at least one contributor change to the data layer when one or more contributor changes are made. Data bundles may be generated upon a change in monitored files and/or folders or may be generated in response to a command by contributor 104.

Contributor tool 206 may also be configured to receive data bundles comprising changes to the data layer and integrate such changes into the data layer stored on contributor computing device 106b. Changes may be made upon receipt of a data bundle or may be commanded by contributor 104.

Contributor changes may be received by one or more data mangers 102. In the aspect depicted in FIG. 2, data manager 102 is an individual. In another aspect, data manager 102 may be a software module or some combination of hardware and software.

As shown in FIG. 2, data manager 102 may monitor, approve, modify, reject, verify, or otherwise manipulate contributor changes received via email message by utilizing a data manager tool 202 presented to data manager 102 within GUI 204a. Data manager 102 may receive email messages comprising data bundles before the contributor changes contained therein are integrated into the data layer stored in information database 122. Data manager tool 202 may be used to access contributor changes contained with a data bundle and present such changes to data manager 102. Data manager 102 may monitor, approve, modify, reject, verify, or otherwise manipulate contributor changes presented to data manager 102 by data manager tool 202.

Data manager tool 202 may be configured to send or integrate approved contributor changes to the data layer stored in information database 122, thus creating an updated data layer. Data manager tool 202 may also be configured to send, via email message, updates to data layers stored on contributor computing devices 106b.

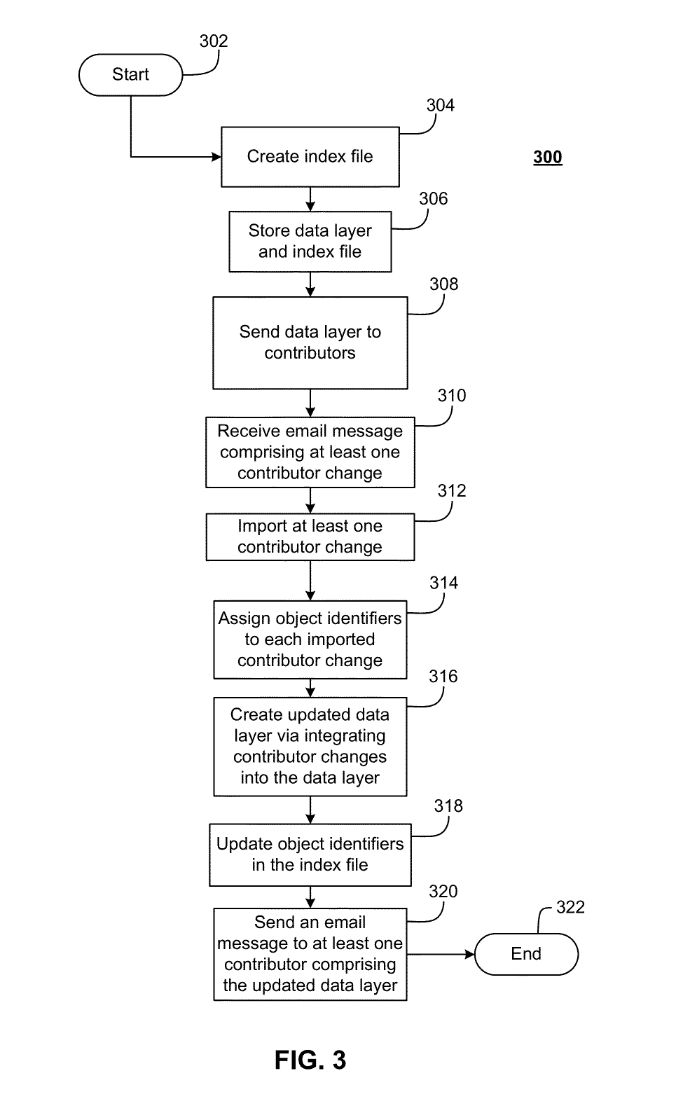

Referring now to FIG. 3, a flowchart of a process 300 for facilitating the creation and management of a data layer, according to an aspect of the present disclosure, is shown.

Process 300, which may execute within system 100 and facilitate creation and management of a data layer, begins at step 302 with control passing immediately to step 304.

In step 304, an index file is created. The index file is associated with one or more files wherein the one or more files are portions of a data layer. The index file may be created by infrastructure 101, data manager computing device 106, a contributor computing device 106, or some other means. At least one object identifier contained in the index file is associated with a portion of the data layer. At least one other object identifier contained in the index file is reserved for later association with a change made to the data layer by contributor 104 or data manager 102 (e.g., addition or deletion of code, addition of geospatial data, editing a text file, addition of images, and the like).

In an aspect, the data layer is associated with the transfer and synchronization of geospatial data. The data layer comprises a shapefile.

In data layer may further comprise a master topology file (.MTF file), comprising relevant geometry, attributes, and projections associated with geospatial information to be transferred and synchronized.

The index file may be a master index file (.MIF file), comprising one or more files which are comprised of assigned and reserved object identifiers. In another aspect, the .MIF file is comprised of records of assigned and reserved object identifiers.

In another aspect, an index file is created for each individual file within a data layer.

In another aspect, object identifiers are not reserved for later association with a change made to the data layer by contributor 104. Rather, in such an aspect, when changes are made object identifiers are associated with such changes and added to the index layer (e.g., through concatenation).

In step 306, the data layer and index file are stored. In an aspect where an information database 122 is utilized, the data layer and index file may be stored on the information database 122. In an aspect where an information database 122 is not utilized, the data layer and index file may be stored on a data manager computing device 106, a contributor computing device 106, or at some other location.

In step 308, the data layer is sent to one or more contributors 104. The data layer may be sent via email message, as where the data layer is an attachment to an email. It may be sent in a proprietary file format only accessible within system 100. The data layer may also be sent in a file format compatible with other viewing and editing programs.

In another aspect, the data layer is sent to one or more contributors 104 via direct file transfer over Internet 108. The data layer may also be sent via some other means which utilizes ports, protocols, and services associated with electronic mail. The data layer may also be sent via transfer of physical media containing the data layer.

In step 310, a data bundle is received in an email message at an email address. The data bundle comprises at least one contributor change to the data layer. The contributor change is an addition, deletion, or other alteration of at least one portion of the data layer which has been made by contributor 104. Upon receipt of the email message at an email address, data manager 102 may access the email and download the data bundle. In another aspect, monitoring of the email address for new data bundle email messages and downloading of the data bundles is automatically performed by a software module.

In step 312, at least one contributor change is imported to a computing device 106. Computing device may be data manager's computing device 106a. Computing device may be infrastructure 101, contributor computing device 106b-e, or some other means.

In an aspect, only contributor changes approved by data manager 102 are imported.

In step 314, object identifiers are assigned to imported contributor changes. Object identifiers may be assigned to all imported contributor changes. In another aspect, object identifiers are assigned only to imported contributed changes which have been approved by data manager 102. In yet another aspect, object identifiers are assigned only to those imported contributor changes which will be integrated into the data layer.

Object identifiers assigned to imported contributor changes may be those object identifiers which have been reserved for later association with a change made to the data layer by contributor 104.

In step 316, the data layer is updated. Updates to the data layer may be facilitated by integrating one or more imported contributor changes into the data layer contained on data manager computing device 106, data manager tool 202, a portion of infrastructure 101, information database 122, or some other device. Such updates form an updated data layer from which contributor computing devices will be updated to match. In this manner, the updates are done to a “master” data layer.

In step 318, the index file is updated to reflect object identifiers being used in conjunction with portions of the updated data layer. In this manner, a continuous record may be kept indicating when changes were made to the data layer, when such changes were approved, and who made such changes.

In an aspect, steps 316 and 318 comprise the following actions: an imported contributor change is accepted as a contribution to the data layer followed by updates to data layer metadata and various file types associated with the data layer (e.g., .MTF files, .MIF files, .TXT files, and the like). Where a relational database management system is used for storage of the data layer, such changes and updates may be appended to the data contained therein.

In step 320, changes to the data layer are sent to one or more contributors 104. Changes may be sent by automatically transmitting an email message to designated contributor 104 email addresses. Such email messages may comprise a data bundle containing the data necessary to update the data layer on contributor computing device 106 to mirror the updated data layer. In another aspect, such email messages may comprise the entirety of the updated data layer. Changes may also be sent via data manager 102 command.

Process 300 then terminates at step 322.

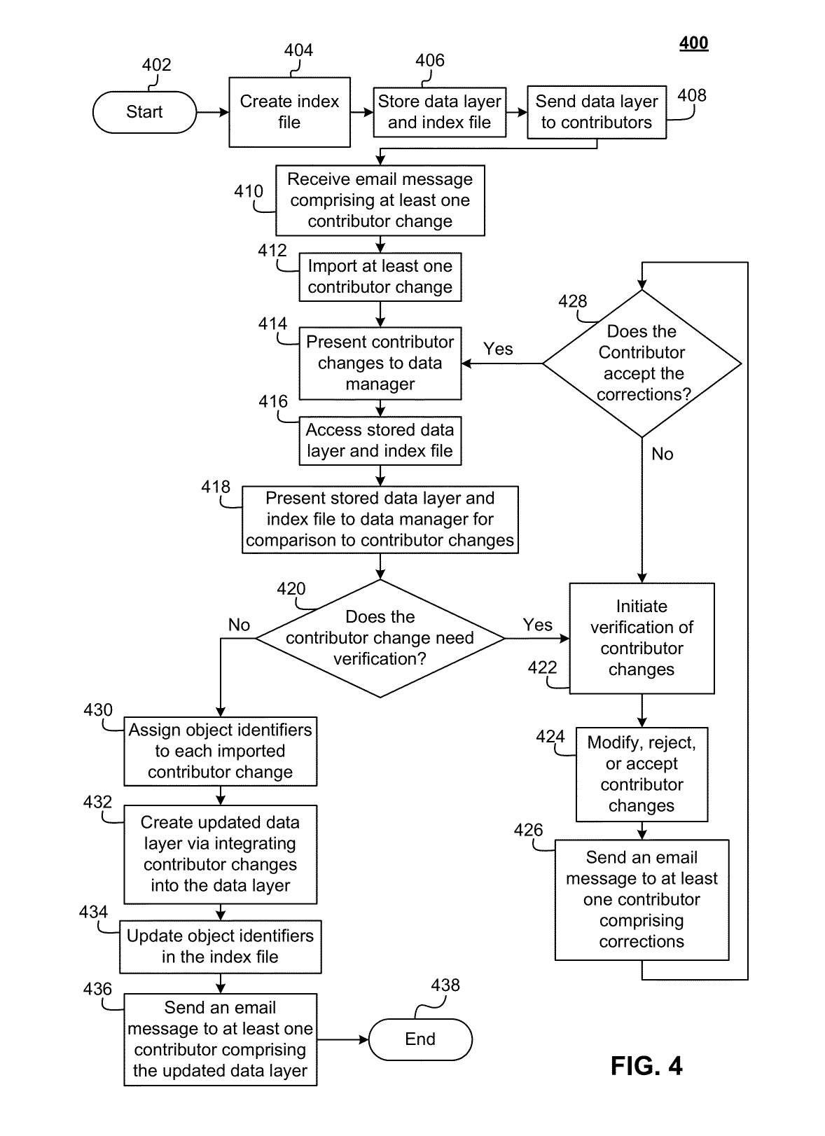

Referring now to FIG. 4, a flowchart of a process 400 for facilitating the creation, alteration, and management of a data layer wherein contributor 104 responds to data manager's 102 corrections, according to an aspect of the present disclosure, is shown.

Process 400, which may execute within system 100 and facilitate creation and management of a data layer, begins at step 402 with control passing immediately to step 404.

In step 404, an index file is created. The index file is associated with one or more files wherein the one or more files are portions of a data layer.

In step 406, the data layer and index file are stored. In an aspect where an information database 122 is utilized, the data layer and index file may be stored onto information database 122. In an aspect where an information database 122 is not utilized, the data layer and index file may be stored on a data manager's computing device 106a, a contributor computing device 106b-e, or at some other location.

In step 408, the data layer is sent to one or more contributors 104. The data layer may be sent via email message, as where the data layer is an attachment to an email. It may be sent in a proprietary file format only accessible within system 100. The data layer may also be sent in a file format compatible with other viewing and editing programs (e.g., *.doc, *.txt, *.pdf, *.wpd, *.rtf and the like).

In step 410, a data bundle is received in an email message at an email address.

In step 412, at least one contributor change is imported to a computing device 106. Computing device may be data manager's computing device 106a. Computing device may be infrastructure 101, contributor computing device 106b-e, or some other means.

Steps 414-428 describe a process for analyzing and verifying contributor change data. This process, described in more detail below, may be performed by a module of a platform in accordance with this disclosure. This process may be performed for each contributor change received. In another aspect, this process is performed for a select subset of contributor changes, where such subset is chosen by data manager according to one or more criteria such as percentage of data changed, anomalous reporting, changes submitted by a specific contributor 104, and the like. In another aspect, a subset of contributor changes are chosen at random and analyzed.

In step 414, contributor changes are presented to data manager 102. In an aspect, contributor changes are presented for approval prior to being integrated into the data layer. Contributor changes may be presented to data manager 102 via data manager tool 202 presented within GUI 204 on computing device 106.

In step 416, the stored data layer and index file are accessed for comparison to the one or more contributor changes presented to data manager 102 in step 414.

In step 418, data manager 102 is presented with at least a portion of the data layer for comparison to imported contributor changes. Comparison may be done visually, aurally, or by any other relevant means. A portion of the index file may also be presented to data manager 102. The portion of the data layer presented and the portion of the index file presented may be via data manager tool 202 within GUI 204 on computing device 106.

In step 420, a determination about the contributor change is made. Data manager 102 determines if the presented contributor change needs verification. Verification may be needed where the contributor change alters or adds an amount of data contained in the data layer above a specified threshold. Verification may also be desirable as a quality control measure. As will be appreciated to those skilled in the relevant art(s) after reading the description herein, verification may be needed or desirable for other reasons.

If no verification is needed, process 400 proceeds to step 430. If verification is needed, process 400 proceeds to step 422.

In step 422, the verification process is initiated and control passes to step 424.

In step 424, data manager 102 may alter the one or more contributor changes subject to the verification process. Data manager 102 may examine a contributor change or compare the contributor change to portions of the data layer. Data manager 102 may also compare the contributor change to third-party data (e.g., comparing received geospatial data to a third-party map). In an aspect, data manager 102 may accept, modify, reject, or otherwise alter the contributor change, based at least in part on such comparisons. Alterations made by data manager 102 to the contributor change are deemed “corrections.”

In step 426, an email message comprising corrections produced in step 424 are sent to an email address where they may be accessed by contributor 104. In an aspect, the corrections email message is sent to an email address accessible by the contributor 104 who generated the relevant contributor change. In another aspect, the corrections email message is sent to an email address accessible by one or more other contributors 104 in order to facilitate cross-checking of the collected data.

The corrections email message is configured to prompt the contributor 104 receiving the email message to respond to the correction(s) made by data manager 102. A response may be made by return email or by utilizing contributor tool 206.

In an aspect, updated data layer information is included in the email message comprising corrections. Thus, if contributor 104 accepts the corrections, contributor computing device 106 may be updated without requiring the sending and receiving of additional email messages.

In step 428, contributor 104 accepts or rejects the data manager corrections. If contributor 104 accepts the corrections, step 414 is executed. If contributor 104 rejects the corrections, the verification process may continue by executing step 422. In another aspect (not shown in FIG. 4), process 400 may terminate.

In step 430, object identifiers are assigned to imported contributor changes. In an aspect, object identifiers are assigned only to imported contributed changes which have been approved by data manager 102. In yet another aspect, object identifiers are assigned only to those imported contributor changes which will be integrated into the data layer.

In step 432, the data layer is updated. Updates to the data layer may be facilitated by integrating one or more imported contributor changes into the data layer contained on data manager computing device 106, data manager tool 202, a portion of infrastructure 101, information database 122, or some other device. Such updates form an updated data layer from which contributor computing devices 106 will be updated.

In step 434, the index file is updated to reflect object identifiers being used in conjunction with portions of the updated data layer. In this manner, a continuous record may be kept indicating when changes were made to the data layer, when such changes were approved, and who made such changes.

In step 436, changes to the data layer are sent to one or more contributors 104. Changes may be sent by automatically transmitting an email message to designated contributor emails addresses. Such email messages may comprise a data bundle containing the data necessary to update the data layer on contributor computing device 106 to mirror the updated data layer. In another aspect, such email messages may comprise the entirety of the updated data layer. Changes may also be sent via data manager 102 command.

Process 400 then terminates at step 438.

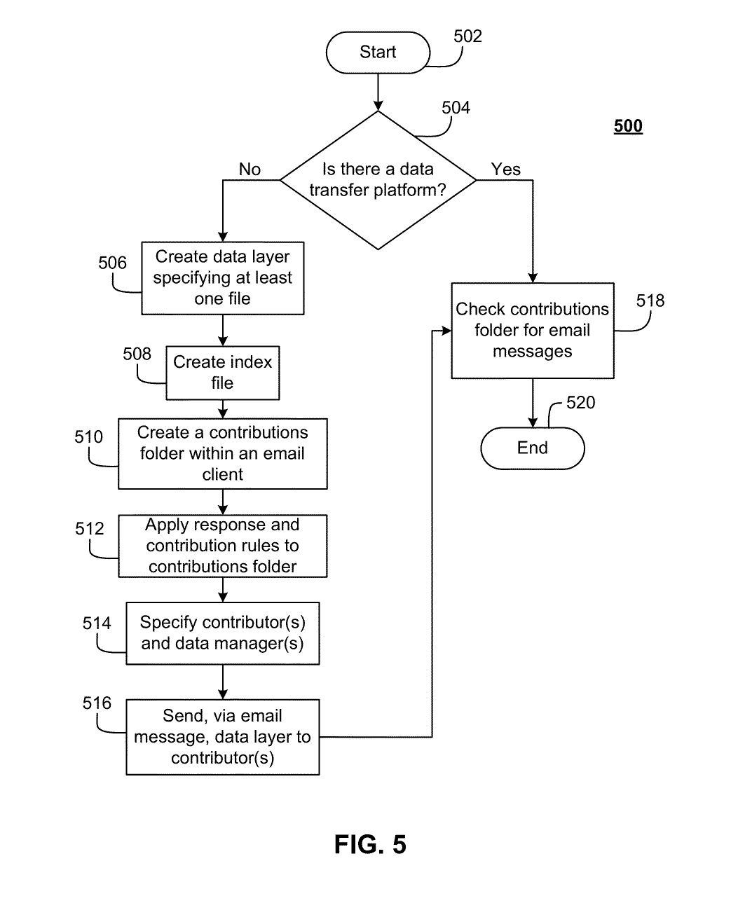

Referring now to FIG. 5, a flowchart of a process 500 for facilitating the creation of a data transfer and synchronization platform, according to an aspect of the present disclosure, is shown.

Process 500, which may execute within system 100 and facilitate creation of a data transfer and synchronization platform, begins at step 502 with control passing immediately to step 504.

In step 504, control passes to step 506 if no data transfer and synchronization platform exists for the data or community in question. If a data transfer and synchronization platform does exist, control passes to step 518.

In step 506, a data layer is created, specifying at least one file to be transferred and synchronized among contributors 104.

In step 508, an index file is created. The index file is associated with one or more files wherein the one or more files are portions of the data layer.

In step 510, a contributions folder is created. The contributions folder is a folder within an email client program configured to receive email messages from one or more contributors 104 which comprise data bundles.

In step 512, rules are created which govern the contributions folder. Such rules may filter incoming messages based on the origin of the message, terms contained within the message or other factors. Such rules may facilitate the automatic importing of data bundles if the received from approved contributors 104. As will be appreciated by those skilled in the relevant art(s) after reading the description herein, other response and contributions rules may be applied at the creation of the contributions folder and at later times in order to facilitate the functionality described herein.

In step 514, a listing file or some other record is created comprising email addresses or other contact information for all data managers 102 and contributors 104 who may initially be given access to the data transfer and synchronization platform. This record may be updated after the creation of the platform. This record may be used in conjunction with the rules created in step 512 to facilitate the functionality described herein (e.g., as a whitelist).

In step 516, the data layer is sent to one or more contributors 104. The data layer may be sent via email message, as where the data layer is an attachment to an email. It may be sent in a proprietary file format only accessible within system 100. The data layer may also be sent in a file format compatible with other viewing and editing programs.

In step 518, the contributions folder is checked for email messages. The contributions folder may be checked periodically by data manager 102 or some portion of infrastructure 101 in order to determine if email messages comprising contributor changes have been received. Process 500 then terminates at step 520.

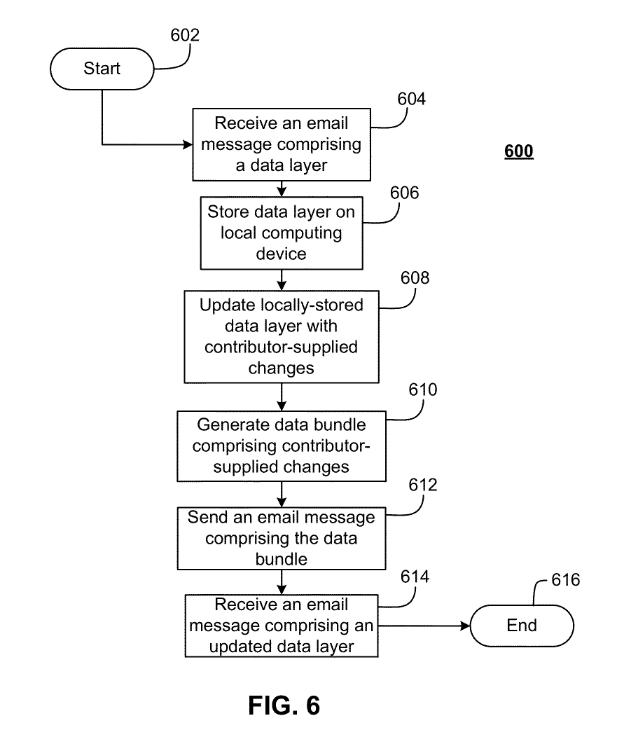

Referring now to FIG. 6, a flowchart of a process 600 for generating and sending contributor changes, according to an aspect of the present disclosure, is shown.

Process 600, which may execute within system 100 and facilitate generating and sending contributor changes, begins at step 602 with control passing immediately to step 604.

In step 604, contributor 104 receives an email message comprising a data layer at a specified email address. The data layer may be sent in a proprietary file format only accessible within system 100. The data layer may also be sent in a file format compatible with other viewing and editing programs.

In step 606, the data layer received via email message is stored on contributor computing device 106. Contributor computing device 106 may further comprise contributor tool 206 which may facilitate the storage and accessing of data layer on contributor computing device 106.

In step 608, contributor 104 updates the data layer stored on contributor computing device 106. Updates to the locally-stored data layer may be performed by inputting, for example, geospatial data collected by contributor 104, editing text files contained in the data layer, or altering or updating data and filed contained in the data layer by some other means. Updates may be made in a third-party editing program and saved to the data layer by the editing program or by contributor tool 206. Updates may be saved to the data layer automatically or may be saved upon receiving a command from a contributor 104. Such contributor commands may be prompted by contributor tool 206 actions, such as a pop-up window.

In step 610, a data bundle comprising at least one contributor change to the data layer is generated by contributor computing device 106. Contributor tool 206 may facilitate the creation of data bundle. In an aspect, such data bundles are created at the end of a session where contributor 104 updates the data layer.

In step 612, the data bundle is sent via email message to an address where the contributor changes contained therein may be transferred and synchronized with other computing devices 106. In an aspect, contributor 104 may send an email message comprising the data bundle from any email address to a specified email address (e.g., contributions@domain.com). In another aspect, email messages containing data bundles may only be sent from specified email addresses. Such a limitation may be desired in order to maintain security protocols.

In step 614, contributor 104 receives an email message comprising an updated data layer at contributor email address or an email address accessible by contributor 104. In another aspect, such email message comprises data configured to synchronize the locally-stored data layer with the updated data layer. That is, the email message does not contain all the data associated with the updated data layer. Rather the email message contains only data necessary to synchronize the locally-stored data layer. Process 600 then terminates at step 616.

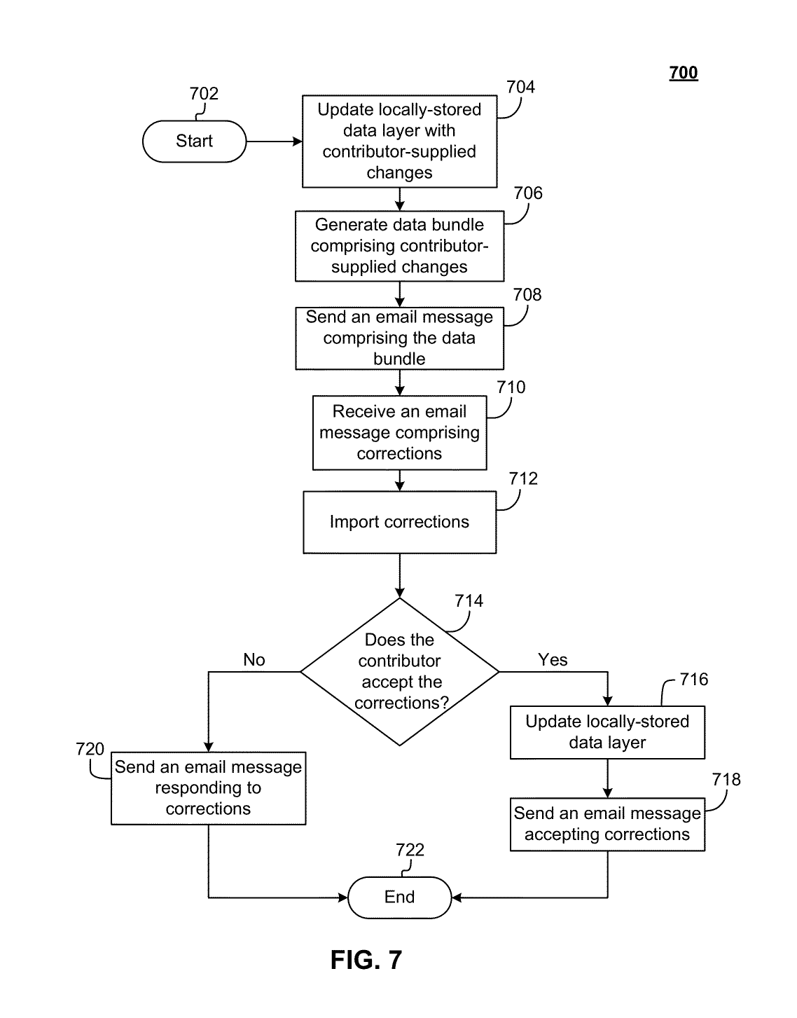

Referring now to FIG. 7, a flowchart of a process 700 for generating and sending contributor changes, wherein contributor 104 responds to corrections, according to an aspect of the present disclosure, is shown.

Process 700, which may execute within system 100 and facilitate generating and sending contributor changes, begins at step 702 with control passing immediately to step 704.

In step 704, contributor 104 updates the data layer stored on contributor computing device 106. Updates to the locally-stored data layer may be performed by inputting, for example, geospatial data collected by contributor 104 or altering or updating data and filed contained in the data layer by some other means. Updates may be made in a third party editing program and saved to the data layer by the editing program or by contributor tool 206. Updates may be saved to the data layer automatically or may be saved upon contributor command. Such contributor commands may be prompted by contributor tool 206 actions, such as a pop-up window.

In step 706, a data bundle comprising at least one contributor change to the data layer is generated by contributor computing device 106. Contributor tool 206 may facilitate the creation of data bundle. In an aspect, such data bundles are created at the end of a session where contributor 104 updates the data layer.

In step 708, the data bundle is sent via email message to an address where the contributor changes contained therein may be transferred and synchronized with other computing devices 106. In an aspect, data manager 102 is the intended recipient of such email message.

In step 710, data manager 102 generates corrections and sends them via email message to contributor 104. Such email message also comprises data configured to update the locally-stored data layer to a synchronized state with the data layer stored on, for example, information database 122 or some other data layer specified by data manager 102. Such email message is received by contributor 104. Contributor 104 imports such corrections onto contributor computing device 106 in step 712.

In step 714, contributor 104 analyzes data manager corrections and accepts or rejects the corrections. Control passes to step 720 if contributor 104 rejects the corrections. If contributor 104 accepts the corrections, control passes to step 716.

In step 716, contributor 104 has accepted the corrections. The locally-stored data layer is updated utilizing data contained in the email message received in step 710.

In step 718, an email message is sent to a designated email address indicating contributor 104 has accepted the contributions. In an aspect, the email message may be sent to data manager 102. In another aspect, the email is sent to a designated email address (e.g., corrections@domain.com).

When contributor 104 rejects the received corrections, an email message responding to the corrections is generated in step 720. The email message may be sent to data manager 102. In another aspect, the email is sent to a designated email address (e.g., corrections@domain.com). The email message may consist only of text explaining, for example, why the corrections were rejected. In another aspect, the email message may comprise revised data, a response generated by contributor tool 206, or other information as will also be apparent to one skilled in the relevant art(s) after reading the description herein.

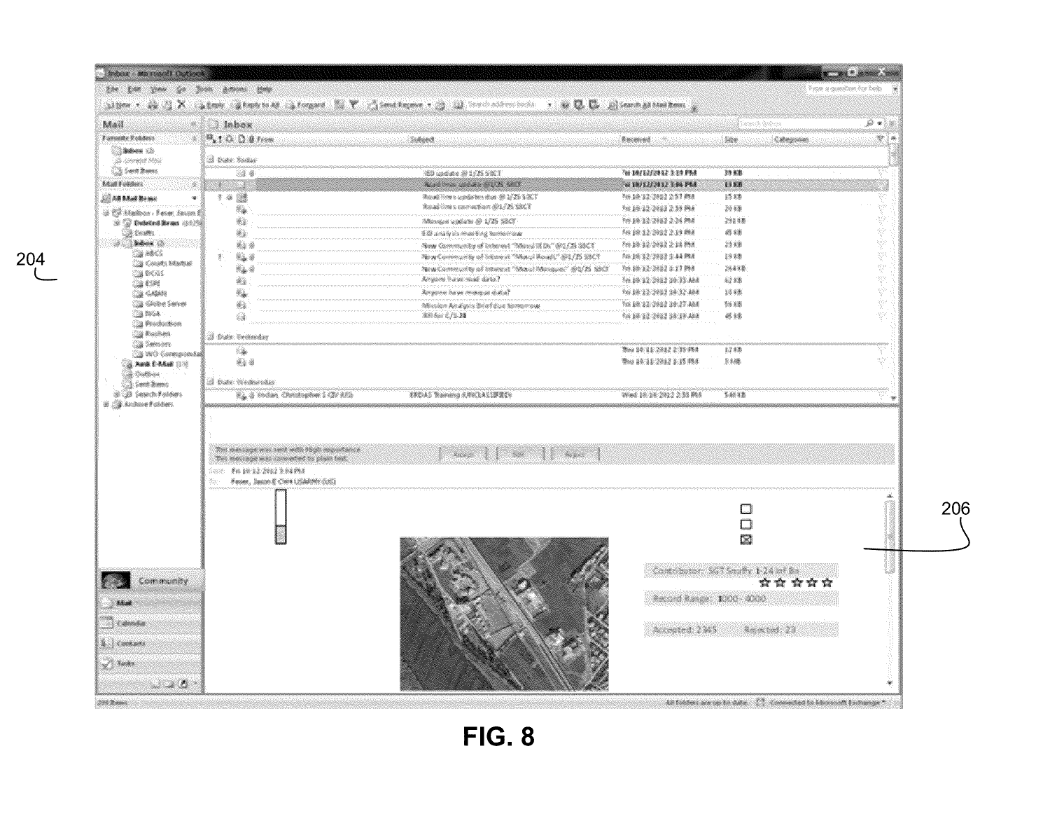

Referring now to FIG. 8, a screenshot of a portion data manager tool 206 displayed within GUI 204, according to an aspect of the present disclosure, is shown.

Data manager tool 202 may be presented to data manager 102 via GUI 204. Such data manager tools 202 may be used to monitor, approve, modify, reject, verify, or otherwise manipulate contributor changes presented to data manager 102 by data manager tool 202. GUI 204 may present data manager with a graphical representation of information in the data layer, such as collected geospatial data, as shown in FIG. 8.

Data manager tool 202 and contributor tool 206 may be implemented within an email client program, such as Microsoft Outlook® (available from Microsoft Corporation of Redmond, Wash.). Data manager tool 202 and contributor tool 206 may be presented to data managers 102 and contributors 104 from within such email client programs.

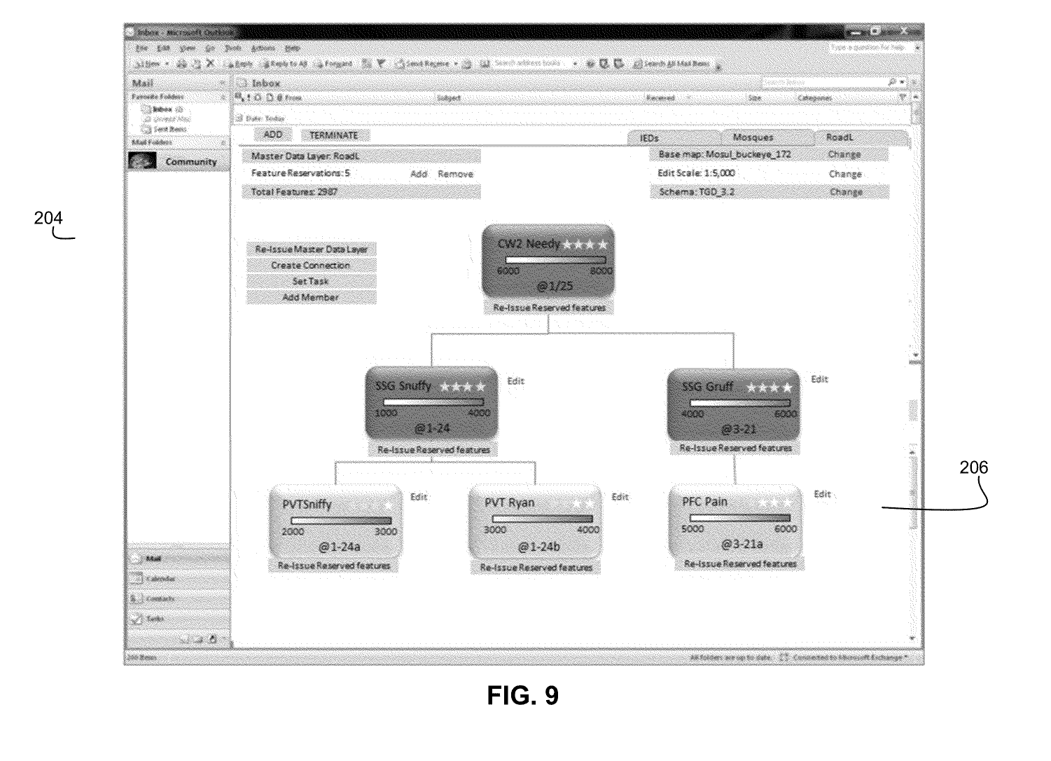

Referring now to FIG. 9, a screenshot of a portion data manager tool 206 displayed within GUI 204, according to an aspect of the present disclosure, is shown.

Data manager tool 206 may present data manager 102 with information about individual contributors 104, such as reliability rating, status of data layer on contributor computing device 106, and the like.

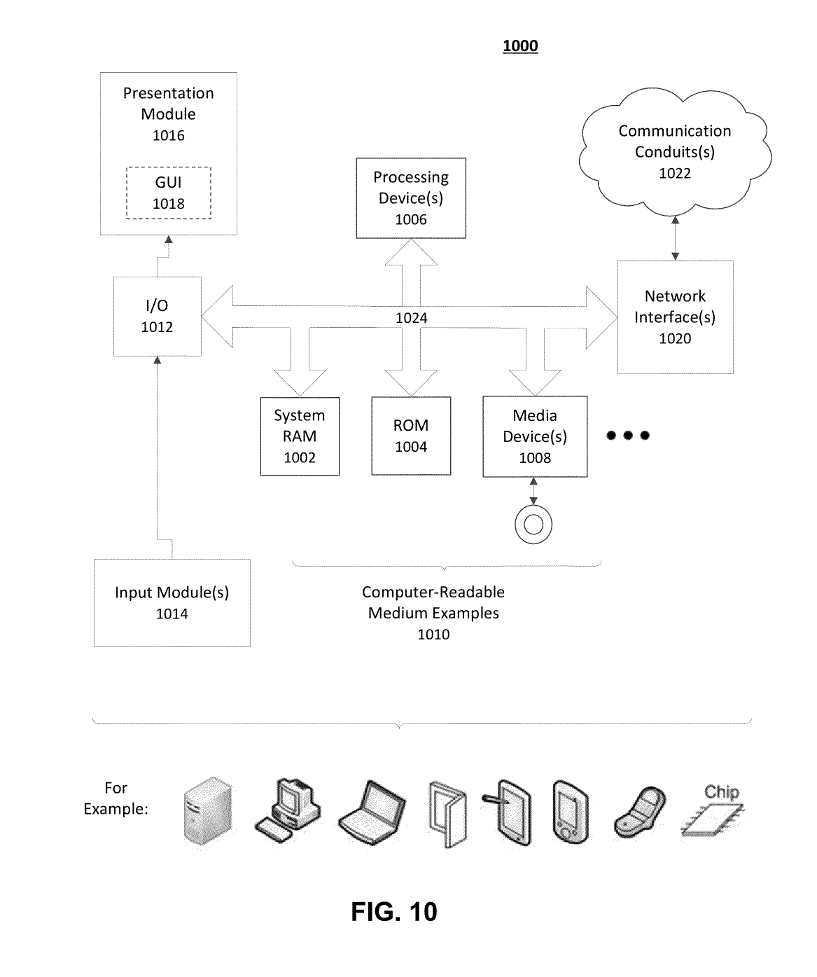

Referring now to FIG. 10, a block diagram of an exemplary computer system useful for implementing various aspects of an enterprise editing platform, in accordance with one or more aspects of the present disclosure, is shown.

FIG. 10 sets forth illustrative computing functionality 1000 that may be used to implement web server 110, devices 106 utilized by data managers 102 and contributors 104 to access Internet 108, or any other component of system 100. In all cases, computing functionality 1000 represents one or more physical and tangible processing mechanisms.

Computing functionality 1000 may comprise volatile and non-volatile memory, such as RAM 1002 and ROM 1004, as well as one or more processing devices 1006 (e.g., one or more central processing units (CPUs), one or more graphical processing units (GPUs), and the like). Computing functionality 1000 also optionally comprises various media devices 1008, such as a hard disk module, an optical disk module, and so forth. Computing functionality 1000 may perform various operations identified above when the processing device(s) 1006 executes instructions that are maintained by memory (e.g., RAM 1002, ROM 1004, and the like).

More generally, instructions and other information may be stored on any computer readable medium 1010, including, but not limited to, static memory storage devices, magnetic storage devices, and optical storage devices. The term “computer readable medium” also encompasses plural storage devices. In all cases, computer readable medium 1010 represents some form of physical and tangible entity. By way of example, and not limitation, computer readable medium 1010 may comprise “computer storage media” and “communications media.”

“Computer storage media” comprises volatile and non-volatile, removable and non-removable media implemented in any method or technology for storage of information, such as computer readable instructions, data structures, program modules or other data. Computer storage media may be, for example, and not limitation, RAM 1002, ROM 1004, EEPROM, Flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically comprise computer readable instructions, data structures, program modules, or other data in a modulated data signal, such as carrier wave or other transport mechanism. Communication media may also comprise any information delivery media. The term “modulated data signal” means a signal that has one or more of its characteristics set or changed in such a manner as to encode information in the signal. By way of example, and not limitation, communication media comprises wired media such as a wired network or direct-wired connection, and wireless media such as acoustic, RF, infrared, and other wireless media. Combinations of any of the above are also included within the scope of computer readable medium.

Computing functionality 1000 may also comprise an input/output module 1012 for receiving various inputs (via input modules 1014), and for providing various outputs (via one or more output modules). One particular output mechanism may be a presentation module 1016 and an associated GUI 1018. Computing functionality 1000 may also include one or more network interfaces 1020 for exchanging data with other devices via one or more communication conduits 1022. In some aspects, one or more communication buses 1024 communicatively couple the above-described components together.

Communication conduit(s) 1022 may be implemented in any manner (e.g., by a local area network, a wide area network (e.g., the Internet), and the like, or any combination thereof). Communication conduit(s) 1022 may include any combination of hardwired links, wireless links, routers, gateway functionality, name servers, and the like, governed by any protocol or combination of protocols.

Alternatively, or in addition, any of the functions described herein may be performed, at least in part, by one or more hardware logic components. For example, without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “module” and “component” as used herein generally represent software, firmware, hardware, or combinations thereof. In the case of a software implementation, the module or component represents program code that performs specified tasks when executed on a processor. The program code may be stored in one or more computer readable memory devices, as described with reference to FIG. 10. The features of the present disclosure described herein are platform-independent, meaning that the techniques can be implemented on a variety of commercial computing platforms having a variety of processors (e.g., desktop, laptop, notebook, tablet computer, personal digital assistant (PDA), mobile telephone, smart telephone, gaming console, and the like).

Those skilled in the relevant art(s), after reading the description herein, will appreciate that portions of processes 300-700 may be facilitated by data manager computing device 106a, data manager tool 202, contributor computing device 106b-e, contributor tool 206, and/or some other means within infrastructure 101.

While various aspects of the present disclosure have been described above, it should be understood that they have been presented by way of example and not limitation. It will be apparent to persons skilled in the relevant art(s) that various changes in form and detail may be made therein without departing from the spirit and scope of the present disclosure. Thus, the present disclosure should not be limited by any of the above described aspects.

In addition, it should be understood that the accompanying figures, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation within computing devices and environments other than those mentioned herein).

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A computer-implemented method for facilitating the operation of a distributed architecture data transfer platform, the method comprising the steps of:
(a) creating an index file on an infrastructure for a data layer, the index file comprising a plurality of object identifiers, the plurality of object identifiers comprising:
an associated object identifier; and
a reserved object identifier,
wherein the associated object identifier is associated with a portion of the data layer and the reserved object identifier is reserved for later assignment to a change made to the data layer by a contributor;
(b) storing the data layer and the index file in an information database;
(c) sending, from the infrastructure and via a first email message, a data layer to the contributor;
(d) receiving, via a second email message sent by the contributor, a data bundle, the data bundle comprising a contributor change to the data layer;
(e) importing the contributor change to the infrastructure;
(f) assigning the reserved object identifier to the contributor change;
(g) creating an updated data layer by integrating the contributor change into the data layer,
wherein the contributor change integrated with the data layer has been assigned the reserved object identifier;
(h) updating the index file with the assignment of the reserved object identifier; and
(i) sending, from the infrastructure and via a third email message, the updated data layer to the contributor.

2. The method of claim 1, wherein the first email message of step (c) and the second email message of step (i) are sent automatically.

3. The method of claim 1, wherein the second email message received from the contributor was generated and sent automatically by a contributor tool.

4. The method of claim 1, further comprising the step of:
(j) sending, from the infrastructure and via a fourth email message, a correction to the contributor, the correction comprising a rejection or modification of the contributor change,
wherein the rejection or modification was made by a data manager and the correction is configured to prompt the contributor to respond to the rejection or modification.

5. The method of claim 4, wherein the data manager is one of: an individual and a software module.

6. The method of claim 4, wherein the data manager is an individual and importing step (e) further comprises the steps of:
(i) presenting the contributor change to the data manager via a computing device graphical user interface;
(ii) accessing the stored data layer and stored index file;
(iii) presenting the stored data layer and the stored index file to the data manager via the computing device graphical user interface,
wherein the graphical user interface is configured to allow the data manager to compare the contributor change to at least one of the stored data layer and to the stored index file, and to accept, reject, or modify the contributor change.

7. The method of claim 1, further comprising the step of:
(k) creating a contributions folder within an email client, configured to receive email messages from the contributor containing data bundles,
wherein the contributions folder is governed by at least one folder rule which causes the email client to take a specified action in response to the received email message.

8. The method of claim 1, wherein the infrastructure utilized in step (a) is one of: a desktop computer; a laptop computer; a PDA; a mobile telephone; a tablet computer; and a mobile computer.

9. A computer-implemented method for facilitating the operation of a distributed architecture data transfer platform, the method comprising the steps of:
(a) storing a data layer on a computing device,
wherein the computing device is accessible by a data manager;
(b) creating an index file on the computing device for the data layer, the index file comprising a plurality of object identifiers, the plurality of object identifiers comprising:
an associated object identifier; and
a reserved object identifier,
wherein the associated object identifier is associated with a portion of the data layer and the reserved object identifier is reserved for later assignment to a change made to the data layer by a contributor;
(c) sending, from a data manager email address and via a first email message, a data layer to the contributor;
(d) receiving, via a second email message, sent by the contributor, a data bundle, the data bundle comprising a contributor change to the data layer;
(e) importing the contributor change onto the computing device;
(f) assigning the reserved object identifier to the contributor change;
(g) creating an updated data layer by integrating the contributor change into the data layer,
wherein the contributor change integrated with the data layer has been assigned the reserved object identifier;
(h) updating the index file with the assigned object identifier; and
(i) sending, from the data manager email address and via a third email message, the updated data layer to the contributor.

10. The method of claim 9, further comprising the step of:
(j) sending, from the data manager email address and via a fourth email message, a correction to the contributor, the correction comprising a rejection or modification of the contributor change,
wherein the rejection or modification was made by the data manager and the correction is configured to prompt the contributor to respond to the rejection or modification.

11. The method of claim 10, wherein the computing device further comprises a graphical user interface and wherein importing step (e) further comprises the steps of:
(i) presenting the contributor change to the data manager via the graphical user interface;
(ii) accessing the stored data layer and stored index file;
(iii) presenting the stored data layer and the stored index file to the data manager via the computing device graphical user interface,
wherein the graphical user interface is configured to allow the data manager to compare the contributor change to at least one of the stored data layer and to the stored index file, and to accept, reject, or modify the contributor change.

12. The method of claim 9, further comprising the step of:
(k) creating a contributions folder within an email client, configured to receive email messages from the contributor containing data bundles,
wherein the contributions folder is governed by at least one folder rule which causes the email client to take a specified action in response to the received email message.

13. A computer-implemented method for facilitating the operation of a distributed architecture data transfer platform, the method comprising the steps of:
(a) receiving, via a first email message sent to a contributor, a data layer;
(b) storing the data layer on a contributor computing device;
(c) updating the stored data layer via integrating contributor-supplied changes into the data layer;
(d) generating a data bundle, the data bundle comprising a contributor change to the data layer;
(e) sending, via a second email message, the data bundle to a contributions email address,
wherein the contributions email address has been configured to receive contributor data bundles; and
(f) receiving, via a third email message, an updated data layer.

14. The method of claim 13, further comprising the step of:
(g) receiving, via a fourth email message, a correction comprising a rejection or modification of a sent contributor change,
wherein the correction is configured to prompt the contributor to respond to the rejection or modification.

15. The method of claim 14, further comprising the step of:
(h) sending, via a fifth email message, a response to the correction received in step (g).

16. A computer readable storage medium for storing computer readable instructions, the computer readable instructions facilitating the operation of a distributed architecture data transfer platform, the computer readable instructions comprising:
logic configured to create an index file on an infrastructure for a data layer, the index file comprising a plurality of object identifiers, the plurality of object identifiers comprising:
an associated object identifier; and
a reserved object identifier,
wherein the associated object identifier is associated with a portion of the data layer and the reserved object identifier is reserved for later assignment to a change made to the data layer by a contributor;
logic configured to store the data layer and the index file in an information database;
logic configured to send from the infrastructure and via a first email message, a data layer to the contributor;
logic configured to receive, via a second email message, sent by the contributor, a data bundle, the data bundle comprising a contributor change to the data layer;
logic configured to import the contributor change to the infrastructure;
logic configured to assign the reserved object identifier to the contributor change;
logic configured to create an updated data layer by integrating the contributor change into the data layer,
wherein the contributor change integrated with the data layer has been assigned the reserved object identifier;
logic configured to update the index file with the assignment of the reserved object identifier; and
logic configured to send from the infrastructure and via a third email message, the updated data layer to the contributor.

17. The computer readable storage medium of claim 16, further comprising:
logic configured to send from the infrastructure and via a fourth email message, a correction to the contributor comprising a rejection or modification of the contributor change,
wherein the rejection or modification was made by a data manager and the correction is configured to prompt the contributor to respond to the rejection or modification.

18. The computer readable storage medium of claim 17, wherein the data manager is one of: an individual and a software module.

19. The computer readable storage medium of claim 17, wherein the data manager is an individual and the computer readable storage medium further comprises:
logic configured to present the contributor change to the data manager via a computing device graphical user interface;
logic configured to access the stored data layer and stored index file;
logic configured to present the stored data layer and the stored index file to the data manager via the computing device graphical user interface,
wherein the graphical user interface is configured to allow the data manager to compare the contributor change to at least one of the stored data layer and to the stored index file, and to accept, reject, or modify the contributor change.

20. The computer readable storage medium of claim 16, further comprising:
logic configured to create a contributions folder within an email client, configured to receive email messages from the contributor containing data bundles,
wherein the contributions folder is governed by at least one folder rule which causes the email client to take a specified action in response to the received email message.
